(19) United States
(12) Patent Application Publication
(10) Pub. No.: US 2018/0044060 A1
(43) Pub. Date: Feb. 15, 2018

(54) PILL CONTAINER KIT

(71) Applicant: William Felix Leahy, Holyoke, MA (US)

(72) Inventor: William Felix Leahy, Holyoke, MA (US)

(21) Appl. No.: 15/232,354

(22) Filed: Aug. 9, 2016

(51) Int. Cl. B65D 25/10; A61J 7/04; B65D 25/28; B65D 43/16; B65D 83/04; A61J 1/03

(52) U.S. Cl. CPC B65D 25/10; B65D 83/04; A61J 1/03; B65D 25/2897; B65D 43/16; A61J 7/04; B65D 2525/283

(57) ABSTRACT

A pill container kit is provided. The pill container kit provides a lid pivotally connected to a main body for moving between a closed and open condition. The body and lid define body and lid interiors, respectively, wherein a respective retaining element substantially fills said interiors but for a plurality of cavities the retaining elements form. Dosage cups are provided in the cavities so that an opening of each dosage cup is accessible in the open configuration, and wherein each of a plurality of daily pill doses are contained in their respective dosage cup a user can easily remove and use.

### BACKGROUND OF THE INVENTION

The present invention relates to pill containers and, more particularly, to a pill container kit having a retainer element adapted so that when the pill container kit is in an open configuration, each of the plurality of daily doses are contained in their respective dosage cup a user can easily remove and use.

Currently pill containers are designed to be compact, easily portable, and so that daily dosages need not be remembered by providing an individual compartment for each day. As a result, current pill containers are difficult to use, often times requiring one to have to pry open a small plastic lid, typically with one's finger nail, for each individual compartment when filling a Monday, Tuesday, Wednesday, etc. pill compartment for the coming week or two.

As can be seen, there is a need for a pill container kit having a retainer element adapted so that when the pill container kit is in an open configuration, each of the plurality of daily doses are contained in their respective dosage cup a user can easily remove and use.

### SUMMARY OF THE INVENTION

In one aspect of the present invention, a pill container kit includes a main body defining a body interior; a lid defining a lid interior; a hinge pivotally connecting to the main body and the lid so the lid moves relative to the main body between a closed condition and an open condition; a body retaining element substantially filling the body interior, wherein the body retaining element forms a plurality of dosage cavities arranged in a grid; and a plurality of time markings adjacent to the plurality of dosage cavities.

In another aspect of the present invention, the pill container kit includes a main body defining a body interior; a lid defining a lid interior; a hinge pivotally connecting to the main body and the lid so the lid moves relative to the main body between a closed condition and an open condition; a body retaining element substantially filling the body interior, wherein the body retaining element forms a plurality of dosage cavities arranged in a grid; a plurality of time markings adjacent to the plurality of dosage cavities, wherein each of the plurality of time markings indicates either a day of the week or a portion of the day; a dosage cup disposed in each dosage cavity so that an opening of each dosage cup faces the lid in the closed condition; an elongated bottle cavity formed by the body retaining element so as to extend substantially the full length thereof; a lid retaining element substantially filling the lid interior, wherein the lid retaining element forms a plurality of dispenser cavities; a dispenser box removably secured in each of the plurality of dispenser cavities; and a dispenser box slidably secured in each dispenser cup. These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in a closed condition;

FIG. 2 is a section view of an exemplary embodiment of the present invention, taken along line 2-2 of FIG. 1;

FIG. 3 is an exploded view of an exemplary embodiment of the present invention, shown in an open condition; and

FIG. 4 is an enlarged view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pill container kit having a retainer element adapted so that when the pill container kit is in an open configuration, each of the plurality of daily doses are contained in their respective dosage cup a user can easily remove and use. The pill container kit provides a lid pivotally connected to a main body for moving between a closed condition and the open condition. The body and lid define body and lid interiors, respectively, wherein a respective retaining element substantially fills said interiors but for a plurality of cavities the retaining elements form. Dosage cups are provided in the cavities so that an opening of each dosage cup is accessible in the open configuration.

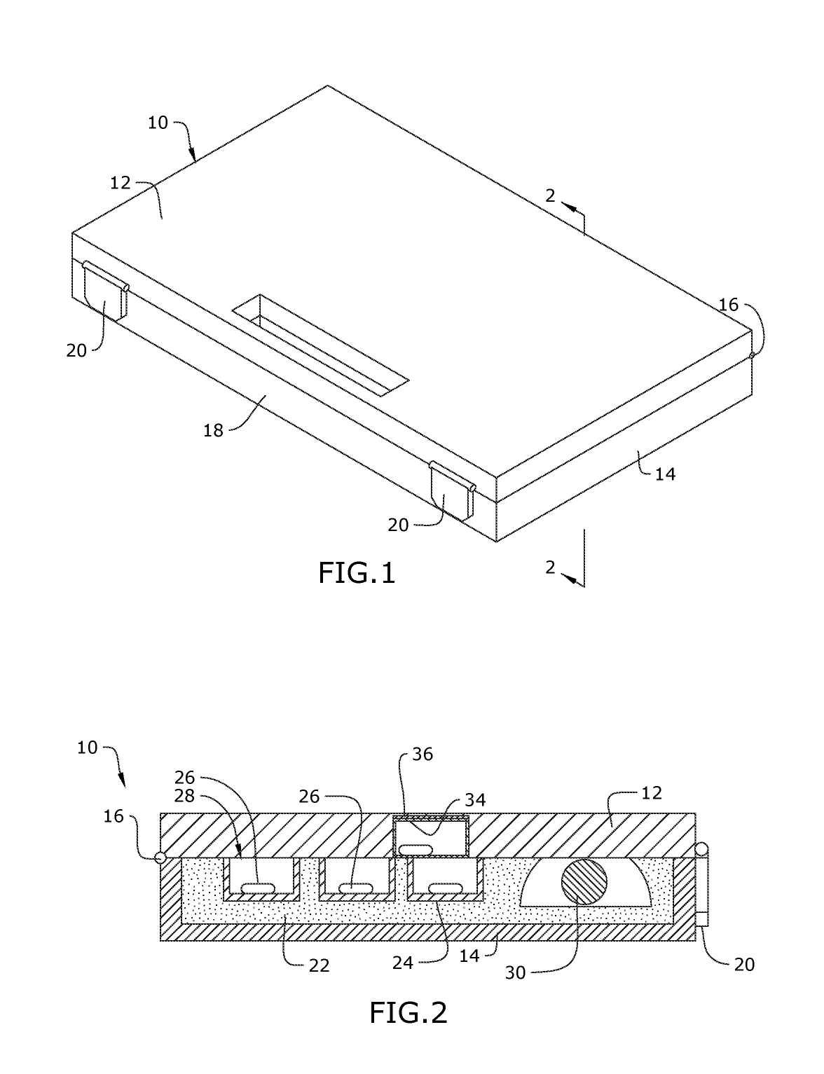

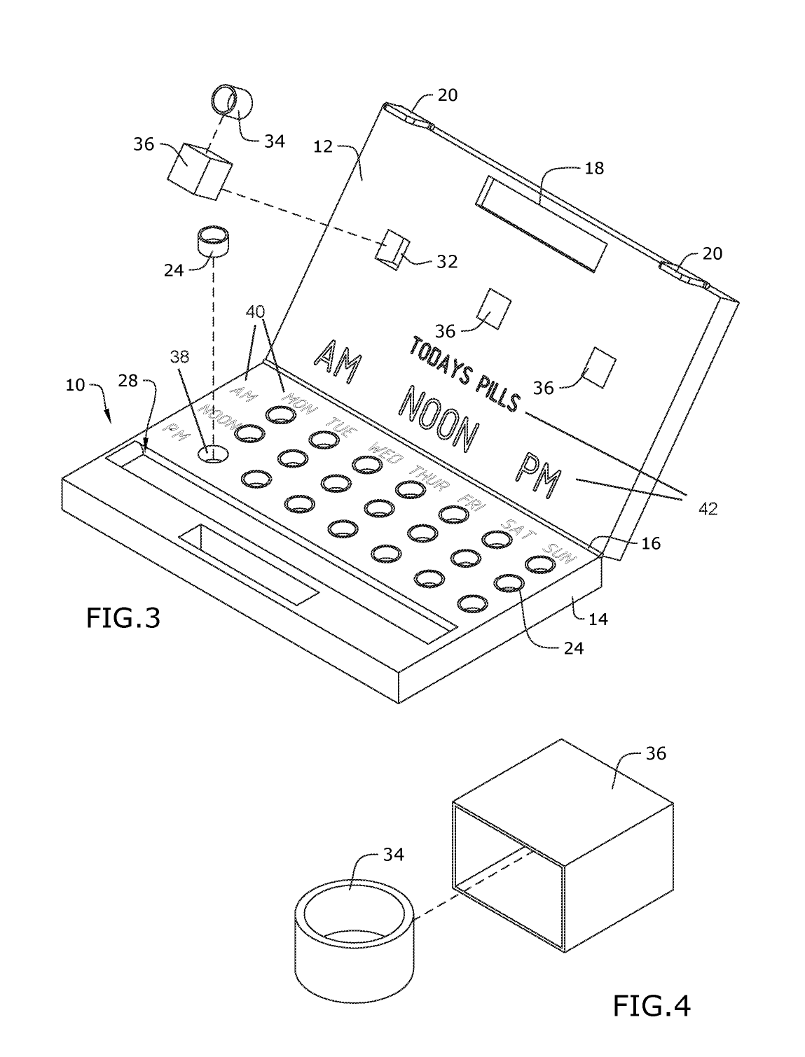

Referring to FIGS. 1 through 4, the present invention may include an exemplary pill container kit 10 providing a housing in the form of a relatively rigid case having a main body 14 and a lid 12. The main body 14 and the lid 12 each have an interior adapted to receive, hold, and maintain the pills 26 and/or desired paraphernalia for the dispensing of said pills 26, namely, a plurality of dosage cups 24, a bottle 30, a plurality of dispenser boxes 36 and dispenser cups 34. It will be appreciated that the main body 14 and the lid 12 define a body interior and a lid interior, respectively, each preferably dimensioned and shaped to substantially yet economically retain typical pills and related paraphernalia so as to provide the interior of sufficient volume. Of course, the housing (and thus the lid 12 and the main body 14) may take any shape so long as it functions within the scope of the present invention.

A hinge 16 may pivotally connect the lid 12 to the main body 12 so that the lid 10 moves relative to the main body 12 between a closed condition and an open condition providing access to the interior.

The lid 12 and main body 14 may provide cooperating handles 18 for manipulating and moving the pill container kit 10, wherein the cooperating handles 18 align in the closed condition. Latches 20 may be connected to the main body 12 and/or the lid 10 so as to move between an unlocked and a locked engagement in the closed condition. Though it should be noted that the latches 20 may be any type of mechanism known in the art used to maintain the lid 12 in the closed condition.

At least one retaining element 22, such as a foam insert, is provided to maintain one or more desired paraphernalia in place within the interior, wherein the retaining element(s) 22 fills the interior but for a plurality of cavities the retaining element 22 forms. The plurality of cavities may include a bottle cavity 28, a plurality of dispenser cavities 32, and a plurality of dosage cavities 38. Such formed cavities of the retaining elements 22 are dimensioned and adapted to enable sliding removal and snug retention of said paraphernalia, while being beneficial in maintaining the predictable order within the interior and reducing any damage that may result from shifting of the desired paraphernalia.

The plurality of dosage cavities 38 may be formed along the body interior in a general grid pattern, as illustrated in FIG. 3. Each dosage cavities 38 may be dimensioned and adapted to slidably receive and snugly retain a respective dosage cups 24. The retaining element(s) 22 may provide time markings 40 adjacent to the plurality of dosage cavities 38. The time markings 40 may indicate the days and times of the week associated with each of the adjacent dosage cavities, taking advantage of the grid pattern arrangement. For example, along a first grid axis the time markings 40 may indicate the day of the week, while along an orthogonal second grid axis the time markings 40 may indicate the time period of day, as illustrated in FIG. 3.

In certain embodiments, the retaining element 22 along the body interior may form the elongated bottle cavity 28 extending substantially the full length of the body interior, wherein the dimensions (width and depth) of the elongated bottle cavity 28 may be adapted so as to secure at least one bottle 30 therein, as illustrated in FIG. 2.

In certain embodiments, the plurality of dispenser cavities 32 may be formed along the lid interior, as illustrated in FIG. 3. Each dispenser cavity 32 may be dimensioned and adapted to snugly receive and secure a slidably removable dispenser box 36. Each dispenser box 36 may be dimensioned and adapted to snugly receive and secure a slidably removable a dispenser cup 34. The dispenser cavities 32 may be associated with pills/medicaments that a user may need to take the current day, wherein daily time markings 42 are associated with at least two time portions of the current day, each daily time markings adjacent to a spaced apart dispenser cavity 32, as illustrated in FIG. 3.

A method of using the present invention may include the following. The pill container kit 10 disclosed above is provided. With the pill container kit 10 in the open condition, a user may remove the dosage cups 24 from its dosage cavity 38 associated with the predetermined day and time period as indicated by the time markings 40 so as to dispensing the pill(s) contained therein. In certain embodiments, the user may use one of the dispenser cups 34. Alternatively, the user may reverse these steps to fill the appropriate dosage cups 24 for future dispensing. Then the user may move the pill container kit 10 to the closed condition, and store and/or transport the pill container kit 10 in the locked engagement.

It should be understood, of course, that the foregoing relates to exemplary embodiments of the invention and that modifications may be made without departing from the spirit and scope of the invention as set forth in the following claims.

What is claimed is:

1. A pill container kit, comprising:
a main body defining a body interior;
a lid defining a lid interior;
a hinge pivotally connecting to the main body and the lid so the lid moves relative to the main body between a closed condition and an open condition;
a body retaining element substantially filling the body interior, wherein the body retaining element forms a plurality of dosage cavities arranged in a grid; and
a plurality of time markings adjacent to the plurality of dosage cavities.

2. The pill container kit of claim 1, wherein each of the plurality of time markings indicates either a day of the week or a portion of the day.

3. The pill container kit of claim 1, further comprising a dosage cup disposed in each dosage cavity so that an opening of each dosage cup faces the lid in the closed condition.

4. The pill container kit of claim 1, further comprising an elongated bottle cavity formed by the body retaining element so as to extend substantially the full length thereof.

5. The pill container kit of claim 1, further comprising a lid retaining element substantially filling the lid interior, wherein the lid retaining element forms a plurality of dispenser cavities.

6. The pill container kit of claim 5, further comprising a dispenser cup removably secured in each of the plurality of dispenser cavities.

7. The pill container kit of claim 6, further comprising a dispenser box slidably securing each dispenser cup in each of the plurality of dispenser cavities.

8. The pill container kit of claim 5, wherein the body and lid retaining elements are foam inserts.

9. The pill container kit of claim 5, further comprising a plurality of daily time markings, each daily time marking adjacent to a respective dispenser cavity of the plurality of dispenser cavities.

10. The pill container kit of claim 9, wherein each of the plurality of daily time markings is associated with a portion of the current day.

11. A pill container kit, comprising:
a main body defining a body interior;
a lid defining a lid interior;
a hinge pivotally connecting to the main body and the lid so the lid moves relative to the main body between a closed condition and an open condition;
a body retaining element substantially filling the body interior, wherein the body retaining element forms a plurality of dosage cavities arranged in a grid;
a plurality of time markings adjacent to the plurality of dosage cavities, wherein each of the plurality of time markings indicates either a day of the week or a portion of the day;
a dosage cup disposed in each dosage cavity so that an opening of each dosage cup faces the lid in the closed condition;
an elongated bottle cavity formed by the body retaining element so as to extend substantially the full length thereof;
a lid retaining element substantially filling the lid interior, wherein the lid retaining element forms a plurality of dispenser cavities;
a dispenser box removably secured in each of the plurality of dispenser cavities; and
a dispenser box slidably secured in each dispenser cup.

12. The pill container kit of claim 11, further comprising a plurality of daily time markings, each daily time marking adjacent to a respective dispenser cavity of the plurality of dispenser cavities, wherein each of the plurality of daily time markings is associated with a portion of the current day.
